(19) United States
(12) Patent Application Publication
(10) Pub. No.: US 2011/0078603 A1
(43) Pub. Date: Mar. 31, 2011

(54) METHOD AND SYSTEM OF PROVIDING SEARCH RESULTS FOR A QUERY

(75) Inventor: George Paulose KOOMULLIL, Bangalore (IN)

(73) Assignee: George Paulose Koomullil, Bangalore (IN)

(21) Appl. No.: 12/698,153

(22) Filed: Feb. 2, 2010

(30) Foreign Application Priority Data
Sep. 29, 2009 (IN) 1572/CHE/2009

(51) Int. Cl. G06F 17/30; G06F 3/048

(52) U.S. Cl. 715/769; 707/741; 715/854; 707/780; 707/E17.108; 707/E17.002; 707/769

(57) ABSTRACT

The present invention provides a method and a system of providing assistance to the user for searching data objects within an application domain over an internet. In one embodiment, this is accomplished by providing the user with a plurality of contexts relating to the application domain, enabling navigation by the user among the plurality of contexts to select one or more contexts, mapping the selected contexts onto a category representing the data objects, and providing the search results relevant to the selected context or contexts.

### TECHNICAL FIELD

The invention relates generally to searching for information, and more particularly providing assistance to a user for searching information relating to an application domain, especially over the internet.

### BACKGROUND

Information on almost any subject is available in the internet in the form of texts, images, audios, and videos. Also, the internet is used in education to search for a topic of interest and to study the information that comes up in the search. Information retrieval comprises the searching for information in documents, searching for documents themselves, searching for metadata which describe documents, as well as searching within data bases. Databases may comprise stand-alone databases or hyper-text network databases such as the World Wide Web (WWW).

A search engine has an information retrieval system designed to help to find information stored in a computer system such as the World Wide Web or inside a proprietary network or within a personal computer of a user. Such a search engine allows a user to seek for content meeting specific criteria which are formed usually by key phrases. A search engine retrieves a list of items that match those input criteria. This list is often sorted according to some measure of relevance. The efficiency of learning a topic is more related to the availability of the relationships between various aspects of the topic. The available information is scattered in nature and the internet does not provide sufficient relation information of the subject. It needs to be more complete and connected to be of use for education and learning. A search engine can be formed by a web search engine which searches for information on the public World Wide Web. Other kinds of search engines can be formed by enterprise search engines which search in intranets of companies. Well-known search engines are for instance “Google”, “Yahoo” or “MSN-search” of Microsoft.

Conventional search engines use a search index which takes into account links from one document to other documents to assign a relevance of a document for a key phrase. A disadvantage of conventional search engines is that they do not integrate the users into the search. In most search engines the user has no influence as to the search process which is performed automatically by the search engine. There is no pro-active feedback by the user to influence the quantity and/or the quality of the search results. Accordingly, it often happens that search results even when listed according to relevance do not meet the expectation of the user, i.e. the listed documents are not the desired documents or relevant documents.

Conventional keyword-based searches use ranking of documents based on the number of occurrences of the keyword within the document. Categorization based searches divide the available documents into different categories for fast retrieval of the documents. Categorization based methods identify patterns using statistical neural network based methods to tag the document with patterns.

In context based document retrieval system as disclosed in U.S. Pat. No. 6,633,868, expressly incorporated herein by reference, proposes “A system and method for context-based document retrieval”, where the context is defined as the statistics of the proximity and occurrence of words throughout the document. The relevance of the documents for a keyword search is computed using a search matrix computed from the keywords and the context database. Even in these context based document retrieval systems the documents are tagged with the proximity and occurrence of words that could still retrieve documents with unrelated context.

Also, there are search engines that catalog web sites based on the context provided by the sites. These search engines can display the web sites and the categories that the web sites belong to as a result of a query. A generalization of that is given in U.S. Pat. No. 6,704,729, expressly incorporated herein by reference, proposes “Retrieval of relevant information categories”, where the available information is categorized, the categories are arranged in a hierarchical taxonomy, and the system displays a cluster of most relevant nodes on predetermined criteria and the query. U.S. Pat. No. 6,704,729 does not provide hierarchical taxonomy of contexts in the domain of interest of the user and also not able to give any freedom to the user to select arbitrary contexts from the hierarchy.

U.S. Pat. No. 6,490,579 expressly incorporated herein by reference, proposes “Search engine system and method utilizing context of heterogeneous information resources” which disclose an improved method of metasearch by including information resource profiles or a grouping of information resource profiles to retrieve information from non-indexed information resources. However, the information resource profiles should include contexts in connection with the existing classification of available information sources. This requires the knowledge of the user to select contexts directly related to existing classification of information sources and hence is not helpful if the user is not aware of the classifiers of existing information resources in terms of their contexts, location, action, and patterns.

All the above prior arts use categories, topics or contexts to categorize the documents and make fast retrieval of the relevant documents. For the reasons stated above, which will become apparent to those skilled in the art upon reading and understanding the present specification, there is a need in the art for a method of providing assistance to the user for searching data objects within an application domain over the internet and receiving (i) search results for a query within a plurality of contexts as desired by the user and thereby providing more relevant search results and (ii) improved user control on the context of the query for obtaining the relevant search results.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to one aspect of the invention there is provided a method of providing assistance to the user for searching data objects within an application domain over an internet, the method comprising: providing the user with a plurality of contexts relating to the application domain, enabling navigation by the user among the plurality of contexts to select one or more contexts, mapping the selected contexts onto a category representing the data objects, and providing the search results relevant to the selected context or contexts.

According to another aspect of the invention there is provided a method of providing assistance to the user for searching data objects within an application domain over an internet, the method comprising: providing a plurality of contexts relating to the application domain at a first level, and providing a plurality of contexts relating to the application domain at a second level using a separate region, said region defining a boundary.

In another aspect, the invention includes a system of providing assistance to the user for searching data objects within an application domain over an internet, the system comprising: a server having a module for providing a plurality of contexts relating to the application domain wherein the contexts are arranged in multiple levels following a hierarchical taxonomical structure.

In another aspect, the invention provides a computer readable medium for storing computer implementable instructions, said instructions for causing a compliance mechanism to perform a method of providing assistance to the user for searching data objects within an application domain over an internet, the method comprising: providing the user with a plurality of contexts relating to the application domain, enabling navigation by the user among the plurality of contexts to select one or more contexts, mapping the selected contexts onto a category representing the data objects, and providing the search results relevant to the selected context or contexts.

In another aspect, the invention provides a computer readable medium for storing computer implementable instructions, said instructions for causing a compliance mechanism to perform a method of providing assistance to the user for searching data objects within an application domain over an internet, the method comprising: providing a plurality of contexts relating to the application domain at a first level, and providing a plurality of contexts relating to the application domain at a second level using a separate region, said region defining a boundary.

Additional advantages and features of the present invention will be more apparent from the detailed description and accompanying drawings, which illustrate preferred embodiments of the invention.

### BRIEF DESCRIPTION OF THE DRAWINGS

FIG. 1 is a block diagram illustrating a computing environment that is suitable for practicing the embodiment of the present invention.

FIG. 2 is a graphical representation of the Branch/Node Taxonomy: Parent-Child relationship used in the invention.

FIGS. 3 & 3(a)-3(c) is a screenshot of Graphical user interface for traversing the hierarchy of contexts according to the present invention.

FIG. 4 illustrates the relationship between parents and children in a tree containing multiple levels where the search for a query can be made within a plurality of contexts available in the tree.

FIG. 5(a)-5(b) shows various applications that can be achieved in accordance with an embodiment of the present invention.

FIG. 6 illustrates an example method of providing assistance to the user for searching data objects within an application domain over an internet.

FIGS. 7 & 7(a)-7(d) shows a screen shot of an exemplary query display that is provided to the user.

FIG. 8 illustrates an example method for selecting contexts from a hierarchical taxonomy of contexts and searching a query within the selected contexts.

FIG. 9 shows sets of categorized data objects, uncategorized data objects, and data objects belonging to the selected context.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in demonstrative embodiments,” “in some embodiment,” “in other embodiments,” or similar language throughout this specification do not necessarily all refer to the same group of embodiments and the described features, structures, or characteristics may be combined in any suitable manner in one or more embodiments.

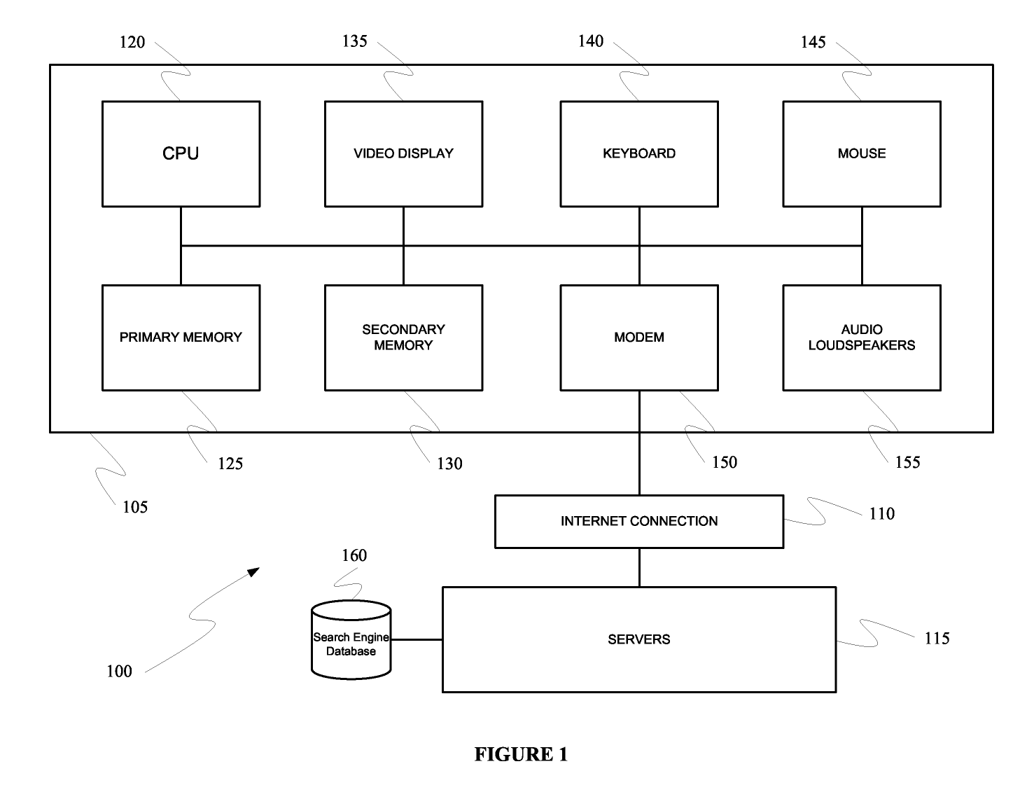

FIG. 1 is a block diagram that shows a computing environment 100 that is suitable for practicing the preferred embodiment of the present invention within this environment 100, client computer 105 is connected with servers 115 via Internet connection 110. The servers 115 are coupled to a search engine database 160. The role of the servers 115 will be discussed in more detail below. The client computer 105 includes a central processing unit (CPU) 120 that has access to a primary memory 125 and a secondary memory 130.

The primary memory includes a copy of a web browser (not shown in figure) for purposes of the discussion below, it is assumed that the web browser is the Microsoft Internet Explorer web browser produced by Microsoft Corporation of Redmond, Wash. The primary memory also holds a copy of an operating system (not shown in figure), such as the Microsoft® Windows® 95 operating system sold by Microsoft Corporation. The primary memory additionally holds a registry (not shown in figure) that holds registered configuration information. The client computer 105 may also include a number of input/output devices, including video display 135, keyboard 140, mouse 145, a modem 150 and audio loudspeakers 155.

Those skilled in the art will appreciate that the computer environment 100 shown in FIG. 1 is intended to be merely illustrative. The present invention may also be practiced in other computing environments. For example, the present invention may be practiced in multiple processor environments wherein the client computer includes multiple processors. Moreover, the client computer need not include all of the input/output devices shown in FIG. 1 and may also include additional input/output devices. Those skilled in the art will appreciate that the present invention may also be practiced with intranets and more generally in distributed environments in which a client computer requires resources from a server computer.

### Branch/Node Taxonomy

### Parent-Child Relationship

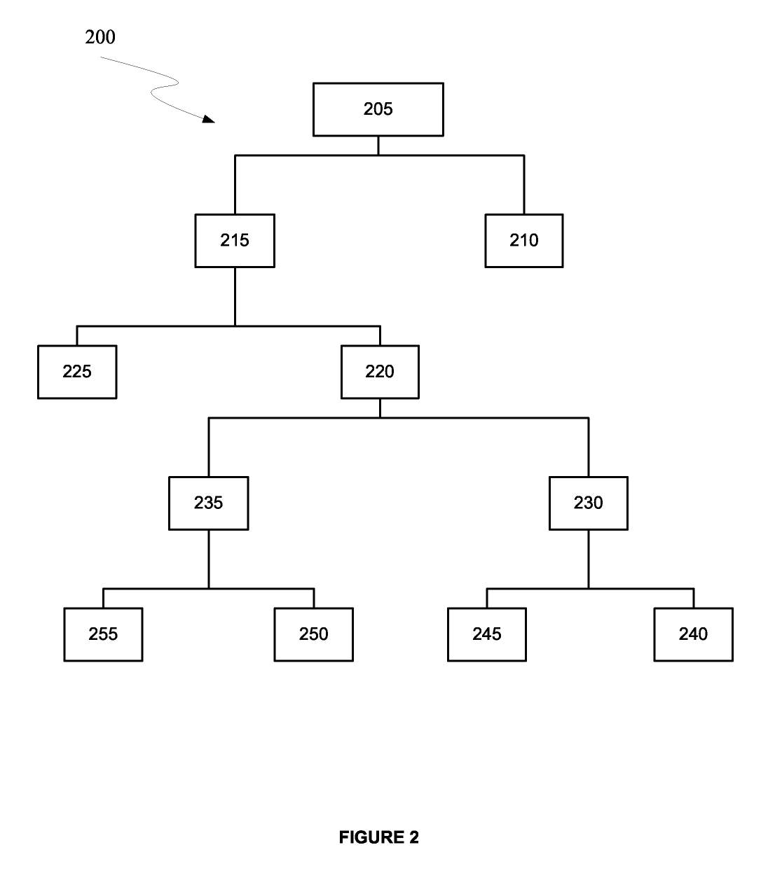

A branch/node taxonomy depicted as a binary tree is one type of hierarchical taxonomy. FIG. 2 illustrates a binary tree 200. A subject node 220 represents the node of interest. In the context of an Internet search engine, subject node 220 may represent one category in the domain of interest of a user's query. A parent node 215 is a node that is one level higher (or one category broader) than the subject node 220, and a grandparent node 205 is two levels higher (or two categories broader than) than subject node 220. Child nodes 230, 235 are nodes that are one level lower than the subject node 220, and the grandchild nodes 240, 245, 250 and 255 are two levels lower than the subject node 220.

A sibling node 225 is a node that is on an equal level with the subject node 220 and associated with the same parent node. Further levels of “great” nodes (not shown) may be present in either direction (e.g., great grandparent and great-great grandchild). As shown in FIG. 2, the grandparent node 205 is the root node, i.e., the highest level node in the binary tree 200. The binary tree may be balanced or unbalanced; however, the nature of a binary tree requires that each node either have exactly two children or no children.

Each node is addressable according to its path in the hierarchical taxonomy. This path is created by traversing the branches connecting subject node 220 with ancestor nodes (i.e. grandparent and parent) and descendent nodes (i.e. children, grandchildren and siblings). This path, called a node path or category path may be written in the form “grandparent/parent/subject node/sibling/child.” Although placing the sibling in the path is not truly hierarchical and may not be necessary, in some instances it may be helpful in placing the category path in its context. By employing such a standard, the relation of the nodes to subject node 220 immediately is apparent, regardless of the node's displayed titles. Notably, the displayed “category paths” may have multiple levels of grandparents (i.e., “great grandparents”) as well as multiple levels of grandchildren (i.e., “great grandchildren”).

One skilled in the art would recognize that the illustration provided in FIG. 2 is an example only and that other parent-child relationships and other structures could be used with the present invention. As an example, the tree can be non-binary and some of the nodes can have multiple parents within the hierarchical taxonomy.

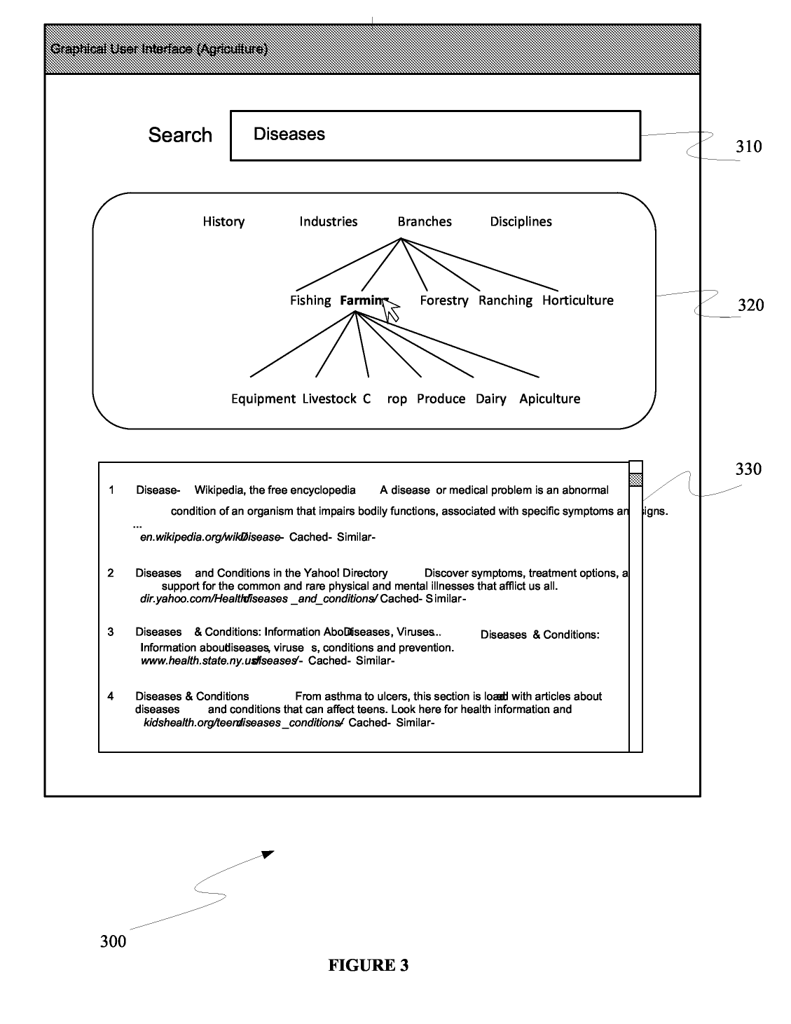

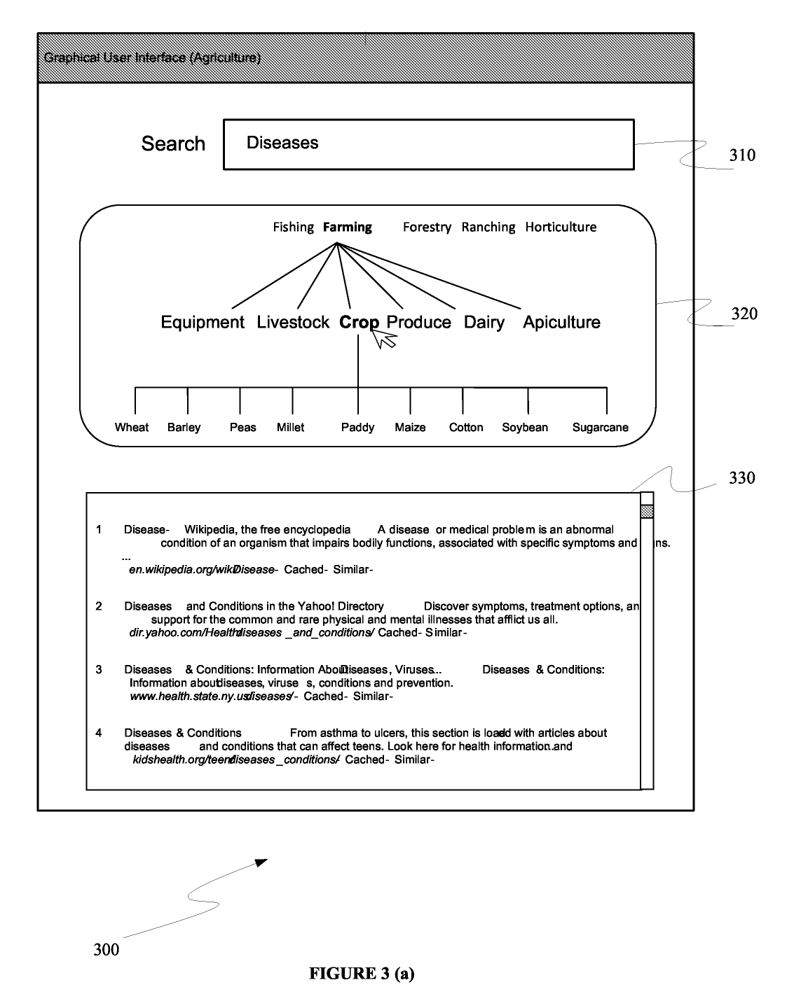

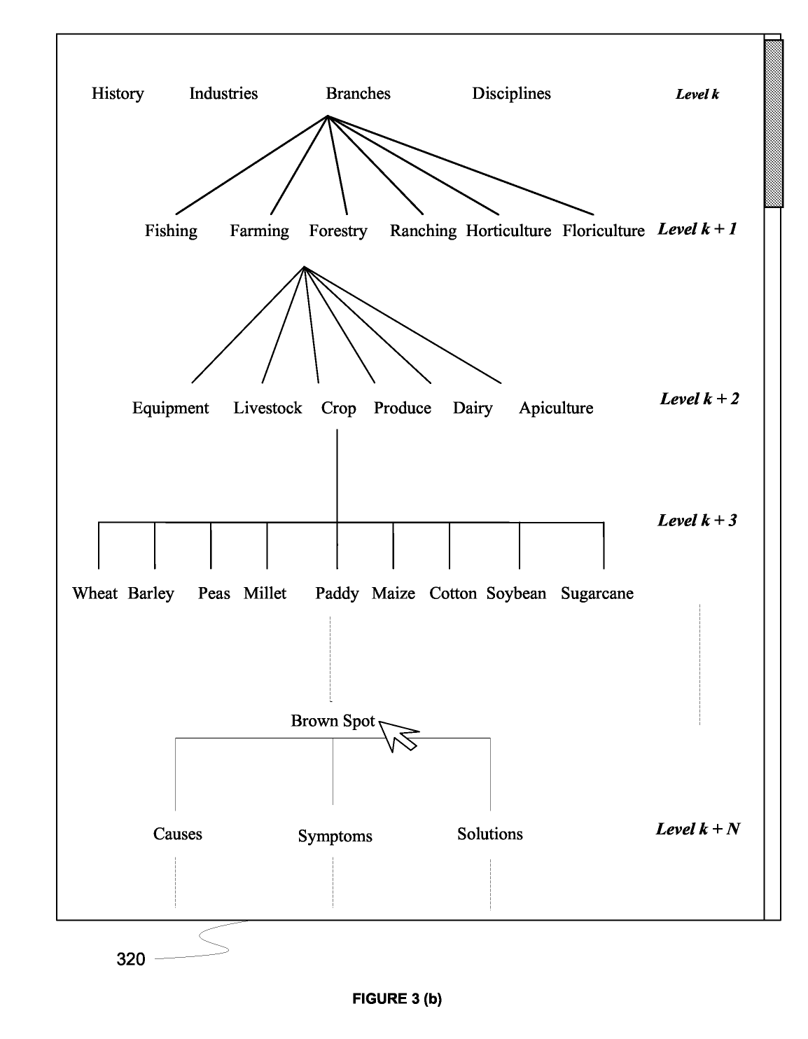

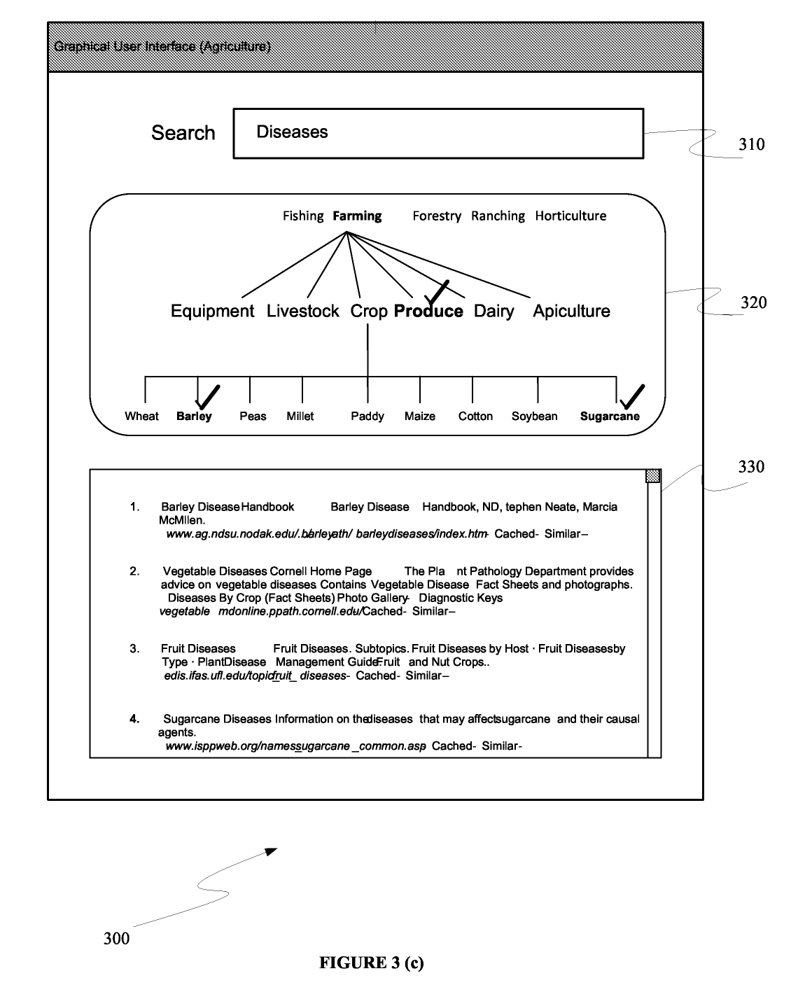

FIG. 3 shows a screenshot of Graphical User Interface (GUI) for traversing the hierarchy of contexts according to one embodiment of the present invention. The GUI includes a query window 310, a graph window 320 and a content window 330. The query window 310 is capable of accepting any query or string from a user. The received query in the query window 310 may be in any language like database query languages or information retrieval query languages (example: SQL). But those skilled in the art would appreciate that other languages could be easily substituted. The graph window 320 provides contexts related to the query, where the contexts are connected together in a hierarchical structure in a number of levels.

Also the graph window is provided with a method to traverse the context from one level to the other level vertically as well as horizontally. This could be achieved for example by using scrolling bars, clicking the mouse within the window and dragging it vertically or horizontally, moving the cursor over a context to receive contexts above and below the selected context, or any other method. The content window 330 configured to display content that can be for example, information displayed as a result of a search. The windows are all related. Modifying, the query statement in the query window 310 automatically triggers the change in the hierarchical structure of the context related to the query in the graph window 320.

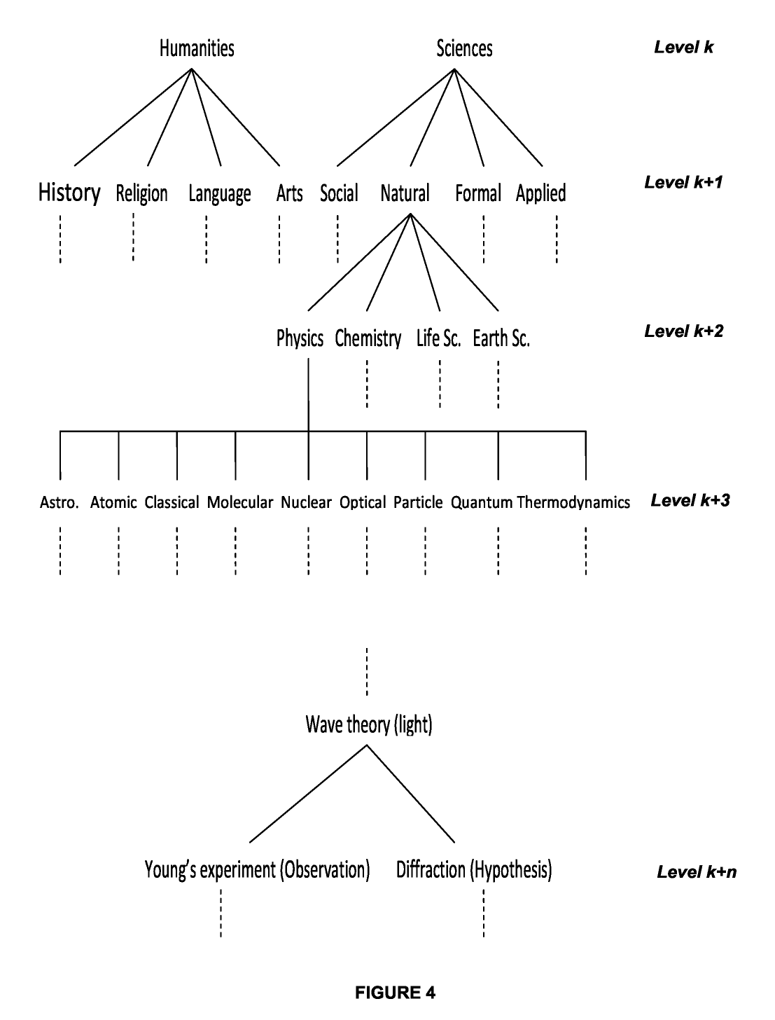

As an example, a farmer looking for information from the internet on a plant disease could run a query within a selected set of contexts to find the cause or remedies of the disease. The selection of the contexts can be made by traversing through a hierarchy of contexts provided by the system. Once the query is inputted in the query window 310, the system generates a graph window 320, where the user can traverse horizontally within the same level and vertically through different levels of the hierarchical taxonomy of contexts. FIG. 4 shows default search results with a query on “diseases”. The graph window 320 showing three levels of contexts as the cursor goes over “Farming”. FIG. 3(a) showing three levels of contexts as the cursor goes over “Crop”. The search results in the content window 330 remains the same as the default results for the query on “diseases”.

The farmer is looking for brown spot disease in the graph window 320 and does a further depth search by moving cursor or by using a scrolling bar. Once the user reaches the brown spot in the graph window 320, the levels of the contexts are further narrowed down by giving the child topics as ‘causes’, ‘symptoms’ and ‘solutions’ (as shown in FIG. 3(b)). The way the user traverses the hierarchy of contexts for the query in the graph window 320 is described below in detail. The initial display consists of a list of relevant contexts at a first level (level k) with some of the contexts selected by default. In addition, the display shows the parent context (level k−1) and child contexts (level k+1) of the selected contexts by default.

When the user selects a different set of contexts at the same level (level k), a new list of relevant parent contexts (level k−1) and child contexts (level k+1) of the selected contexts appear on the display. When the user selects contexts from the list of existing child contexts (level k+1) the display traverses one level lower. Thus, the levels of the new parent contexts become (level k) and that of the child contexts become (level k+2). Similarly, if the user selects a context from (level k−1), the display traverses one level higher.

In FIG. 3(c) describes when the user has selected the contexts as “produce”, “barley” and “sugarcane” (shown in highlighted selection in FIG. 3 (c)), the search results from the query on “diseases” with the selected contexts displayed in the content window 330.

FIG. 4 illustrates the relationship between parents and children in a tree containing multiple levels where the search for string can be made in any one of the contexts available in the tree. In an example, the topic query of ‘light’ can be searched for multiple contexts such as in optics, electrical, particle physics, chemistry, philosophy, astrophysics, thermal, nuclear, history, etc. It should also be noted that the relevance as well as the structure of the tree is not unique. Different relevance and structure of the tree could be resulted from a different keyword or string.

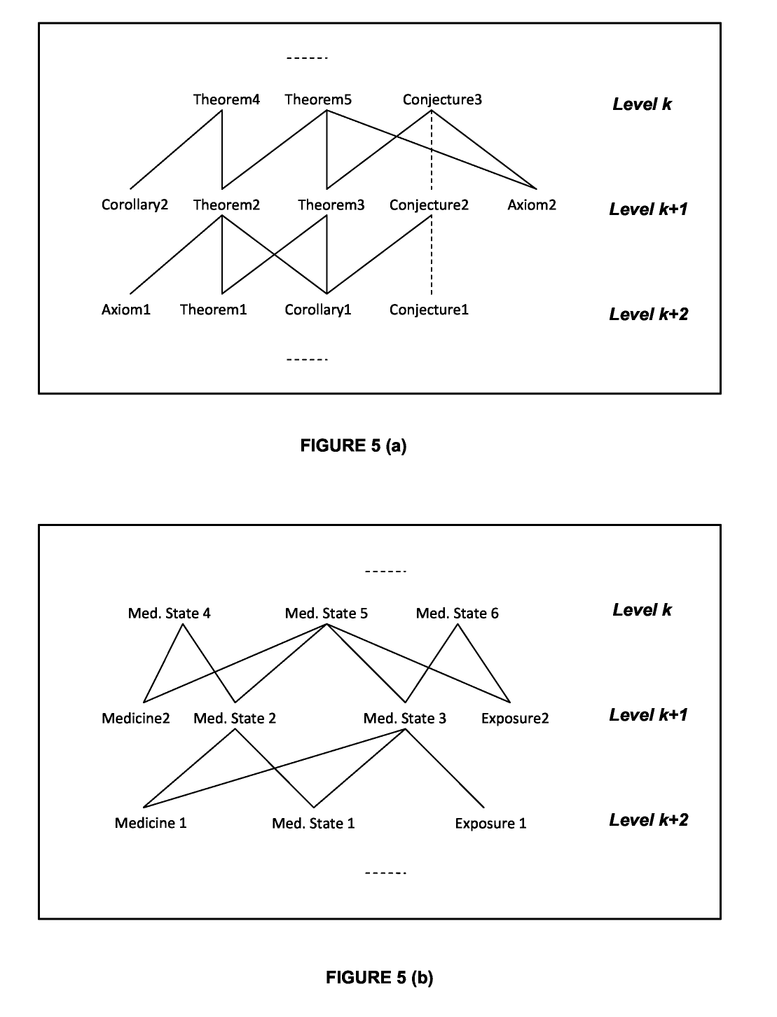

FIG. 5(a) shows an example to illustrate that the same subject (e.g. Mathematics) for different application can be achieved in accordance with an embodiment of the present invention. Keyword search in the context of academic education could contain Mathematics as a context at some level. The search for that application could narrow down the context to one of the topics within Mathematics before the search. The axioms, theorems, conjectures, and corollaries in Mathematics are organized in a parent tree structure as shown in FIG. 5(a).

Theorems or conjectures at level k+1 are deduced from the axioms, theorems, corollaries, and conjectures from level k+2. For example, theorem2 is deduced from axiom1, theorem1, and corollary1. Similarly, conjecture2 is deduced from corollary1 and conjecture1. When a user searches with a string at a particular level of the tree structure, the system comes up with the information relevant to the string in the selected context. The user will be able to move up or down the tree for a new context for the search as described in the present application.

FIG. 5(b) shows an example for Medical application in accordance with an embodiment of the present invention. The transition of the medical state of a patient due to the administration of a medicine or due to a harmful exposure can be represented in a parent-child structure. When the user searches within the system with a keyword, it could come up with a list of context levels to choose from. The keyword can be searched within a specific context. The context can be changed vertically through multiple parent-child levels and horizontally through a context within a given level. Same context (e.g., medicine or exposure) can appear at different levels in the structure and bring up different data objects based on the context level. The user will be able to move horizontally and vertically within the tree structure to select the context and context level for the search.

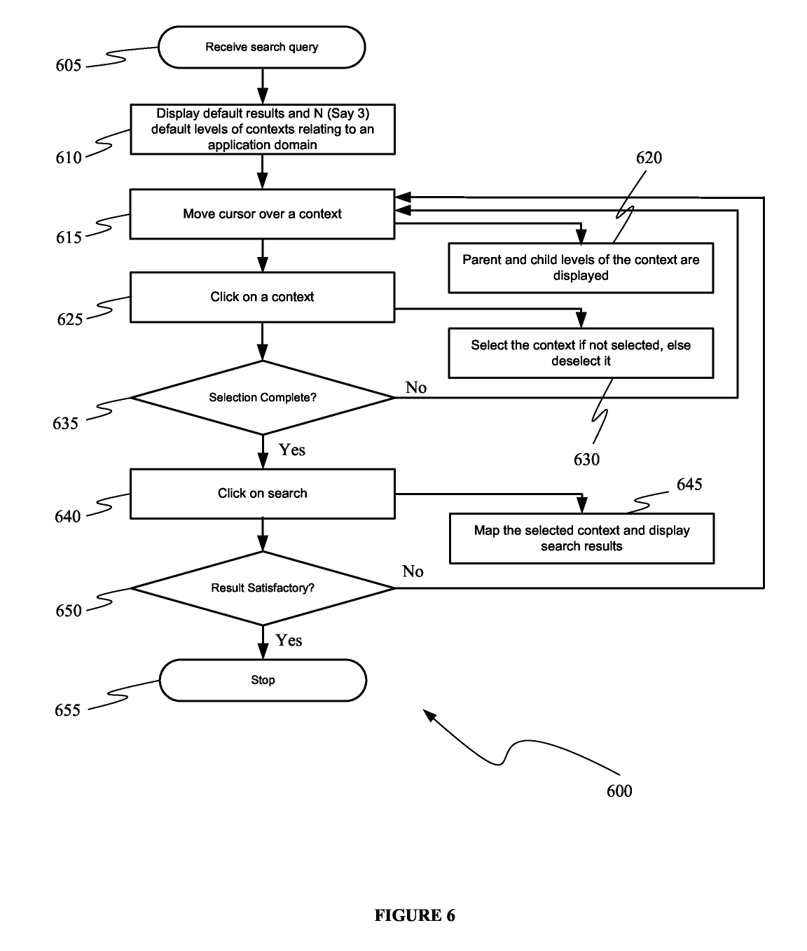

FIG. 6 illustrates an example method 600 for searching the data objects within an application domain over an internet. Examples of the application domain include education, agriculture, medical devices, mathematics etc. At step 605, the method starts the search or it may remain ready for accepting any input from the user. If the query is entered by the user, the query may be generally in a natural language form. The query is indicated as an input query. The input query is provided to a search engine for processing.

At step 610, the method displays default search results. The results are from any of the search engine available at the internet. The default results displayed are in levels (generally in three hierarchical levels) and the default levels of contexts are relating to an application domain. At step 615 the method allows the user to move a cursor over the displayed context as a result parent and child topics of the context are displayed at step 620.

At step 625, the method allows the user to click on a context or contexts with the provided default levels relating to the application domain. Based on the selection, the method displays the results. Also, the user can de-select any of the selected contexts by clicking on already selected context by the user.

At step 635, the method checks whether the user has completed the process of selection. If no, the method enables the user to navigate over the context for further selection (back to step 615). If yes, then the method moves to step 640 and allows the user to click on search which triggers to map the selected context with the data objects available in the internet and display the same at step 645. The data objects available in the internet can be classified into categorized data objects and non-categorized data objects. The selected contexts are mapped to reduce the number of irrelevant data objects and to increase the number of relevant data objects for the search.

Once the mapping is done, at step 650 the method checks whether the result is satisfactory. If No, the method goes to step 615 and allows the user to navigate over the context for further selection. If yes, the method moves to step 655 and stop the search.

The steps followed in a keyword search are explained below.
1. Action: User makes an arbitrary keyword search.
   a. List of default search results appears on a screen.
   b. A set of contexts in multiple levels appears
      i. The default levels of the contexts can be configured initially
      ii. Default selection of levels can be based on a set of criteria of relevance
      iii. Relevance can be based on historical selection of the contexts
      iv. An initial number of contexts can be selected as default
2. Action: User moves the cursor over a context.
   a. Parent and child contexts of the selected context appear
3. Action: User clicks on a context
   a. The context gets selected if it was not already selected and gets deselected if it was already selected.
4. Action: User clicks on a search button
   a. The selected contexts are mapped to categories to reduce the number of irrelevant search results or to increase the number of relevant search results
   b. Search results are displayed

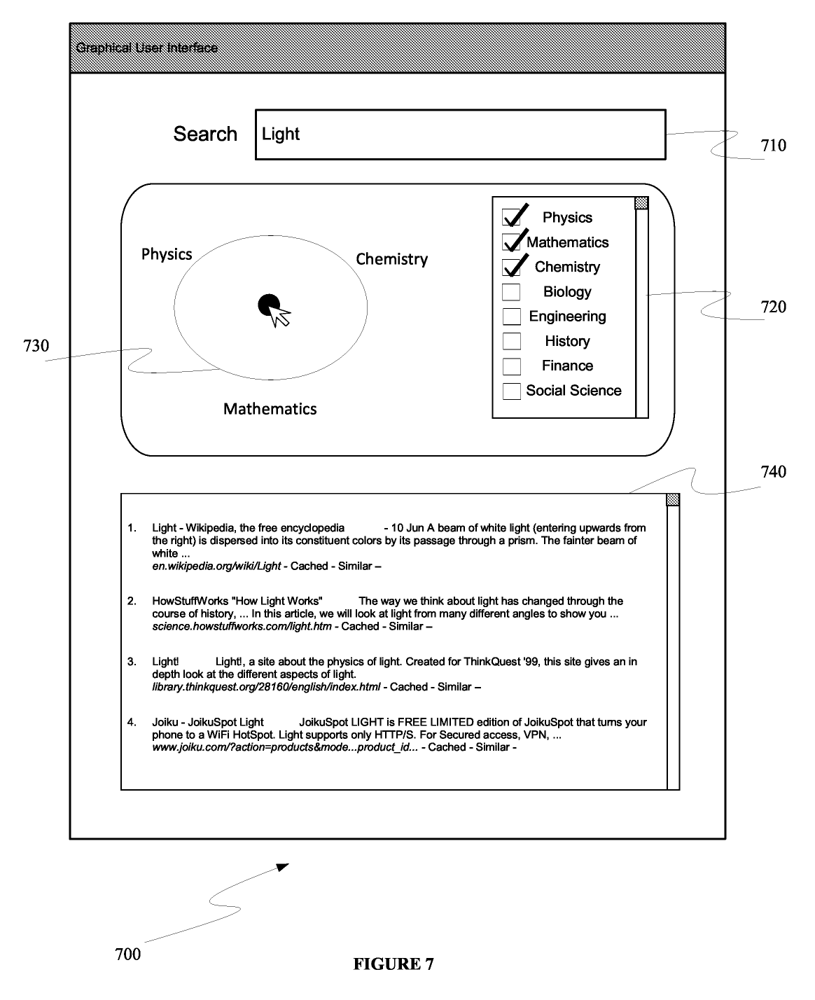

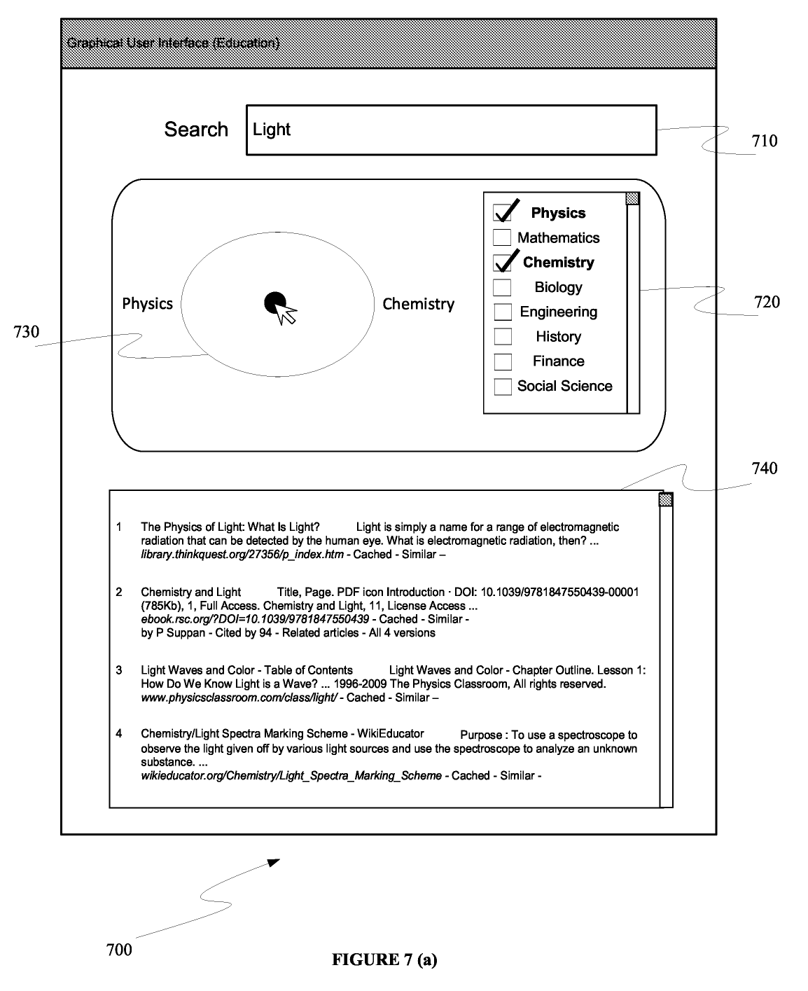

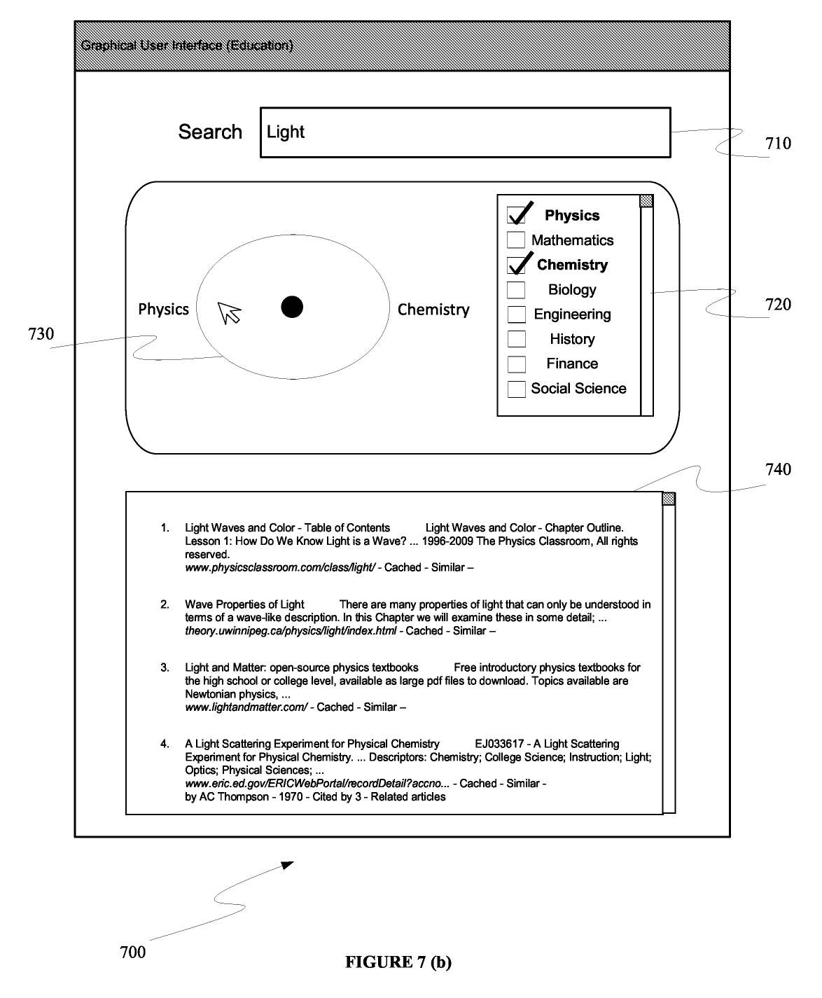

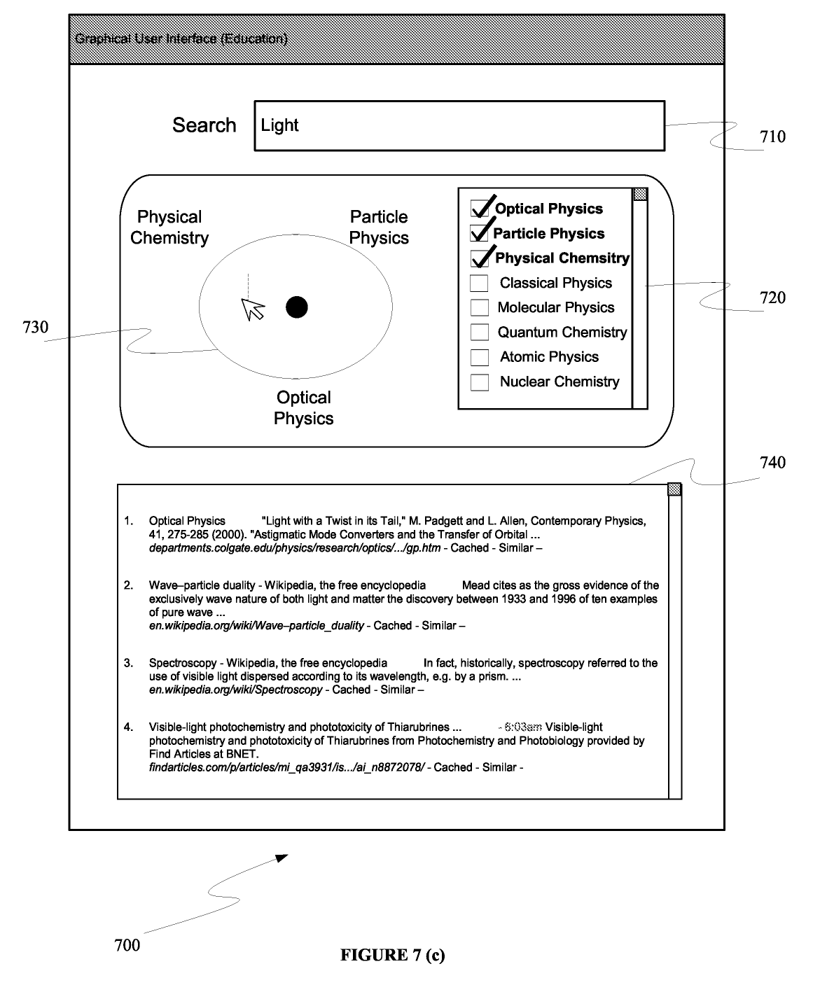

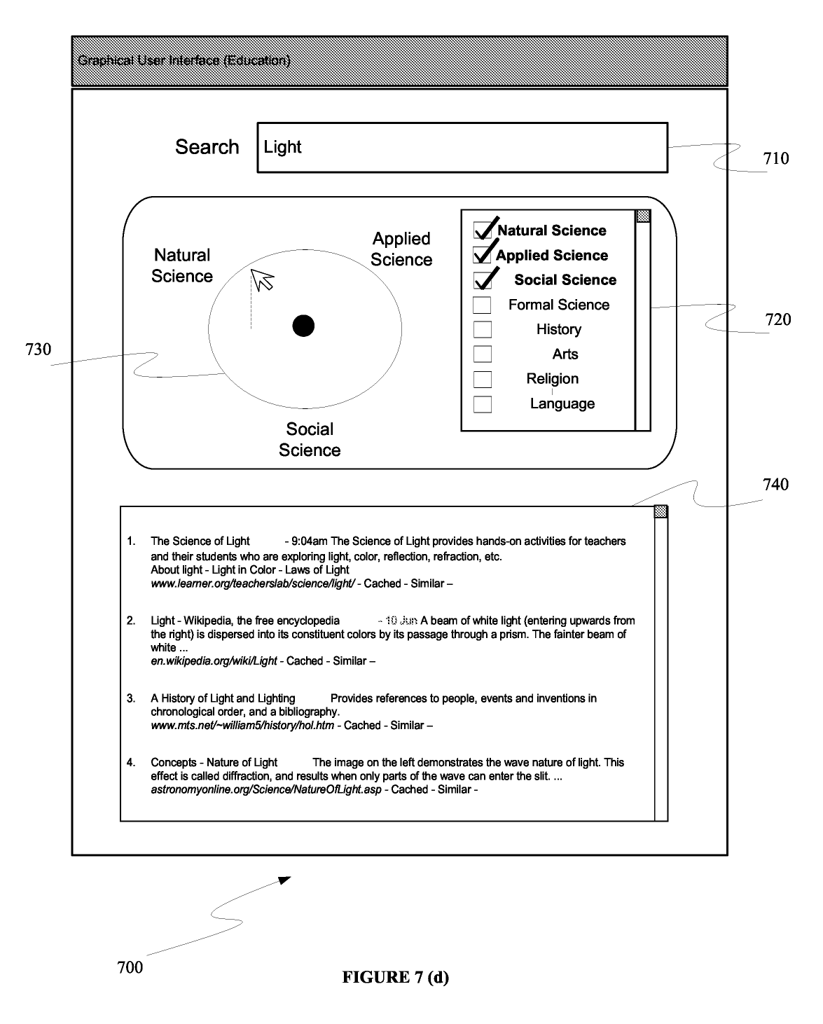

FIG. 7 depicts a screen shot of an exemplary query display that is provided to the user according to one embodiment. A graphical user interface (GUI) 700 includes a query window 710, a list window 720, a graph window 730 and a content window 740. The query window 710 is capable of accepting any query or string from a user. The received query in the query window 710 may be in any language like database query languages or information retrieval query languages (example: SQL). But those skilled in the art would appreciate that other languages could be easily substituted. The list window 720 includes one or more control buttons with scrolling mechanism that can be accessed by the user.

Each control button represents relevant parent topics which could be as wide as possible with respect to the search query. The graph window 730 shows the results of the selected parent topic by the user in the list window 720 in a graphical representation. In the present case, circle chart is used, but the user is free to choose the type of graphical representation, which could be a line chart, a pie chart, a bar chart, a graph, or any other representation. The content window 740 configured to display content that can be for example, information displayed as a result of a search. The windows are all related. Modifying, the query statement results in changes in the list window 720 and the graph window 730 to reflect the new results for the modified query statement.

In an operation, user initiates a session for a keyword search by inputting a query in the query window 710. The system pops-up with the list window 720 including a list of relevant contexts corresponding to the search query. In the list window, a default set of contexts at a default context level are already selected by the system. The default could be one or more, preferably three most appropriate topics or contexts (taken from the history of searches). The system also pops-up the graphical region i.e. graph window 730 (circular region for the present case as an example), representing the selected parent contexts and their combinations.

The circle with a color coding scheme with different colors can be used to show the selected contexts and a mixture of these colors are displayed in the region depending on the closeness of the region to these colors. The color changes from one context to another. There will be a default location of the cursor within the region. Preferably, it could be at the center of the circle as shown in the FIG. 7. Along with the list and the selectable region the system will display a set of default keyword search results in the content window 740.

The user can select a different set of topics from the list window 720 if desired. Once the selection is made by the user, the selected topics will be reflected on the graphical region of the graph window 730. The user is allowed to move the cursor from the default position to another position within the selectable region of the graph window 730 to select a point representing a combination of the selected contexts for the keyword search or query search. Once the point is selected, using a mouse click for example, the content window 740 shows a new list of search results using a combination of the selected contexts as the context for the search. The user can smoothly vary the context from one combination to another.

As an example, if a user searches for ‘light’ in the query window 710 of the system, a list of relevant topics appears on the list window 720 which could be as wide as physics, chemistry, mathematics, biology, etc. as shown in the FIG. 7. Once the user selects a few topics, such as physics and chemistry as in the case here (shown in FIG. 7(a)), a circle with these topics appears on the graph window 730 and contexts relevant to these contexts become available to the user. The selectable region i.e. region on the graph window 730 is for changing the weight-age and hierarchy level of the contexts, and for receiving search results from a query on “light” within the constraints of the selected contexts.

If the user clicks the cursor (as shown in FIG. 7(b)) within the circle closer to a context, search results for the query more relevant to the context will be displayed in the content window 740. In FIG. 7(b) showing highlighted contexts which are selected by the user, the position of the cursor shown within a selectable region, and search results from the query on “light” in accordance with the position of the cursor within the selectable region. In general, the relevance is inversely proportional to the distance of the cursor to the context. If the user clicks and drags downwards on a point within the circle of the graph window 730, a new list of contexts, from a narrower context level, along with a selected default set of contexts will appear in the list window 720. The circle is redrawn (as shown in FIG. 7(c)) with the new selection of contexts corresponding selection made by the user in the list window 720.

In the present case, if the user clicks close to ‘physics’ and drags down, the system generates a new window similar to that shown in the FIG. 7(c) with the topics of optical physics, particle physics, physical chemistry, etc. as the selectable topics. Click the cursor close to optical physics, for example, could search for the keyword, ‘light’, within the context of optical physics. The search results for the selected point on the circular window could be displayed on the content window 740.

In the FIG. 7(c), the default selection of contexts that are one level lower in hierarchy as a result of clicking and dragging downwards on the selectable region i.e. graph window 730. If the user clicks close to ‘optical physics’ and drags up, the system generates a new window similar to that shown in the FIG. 7 (d) with the topics of Natural science, Applied science, Social science, etc. as the contexts. The default selection of contexts that are two levels higher in hierarchy as a result of clicking and dragging upwards on the selectable region i.e. graph window 730. The number of levels traversed is proportional to the distance dragged by the cursor.

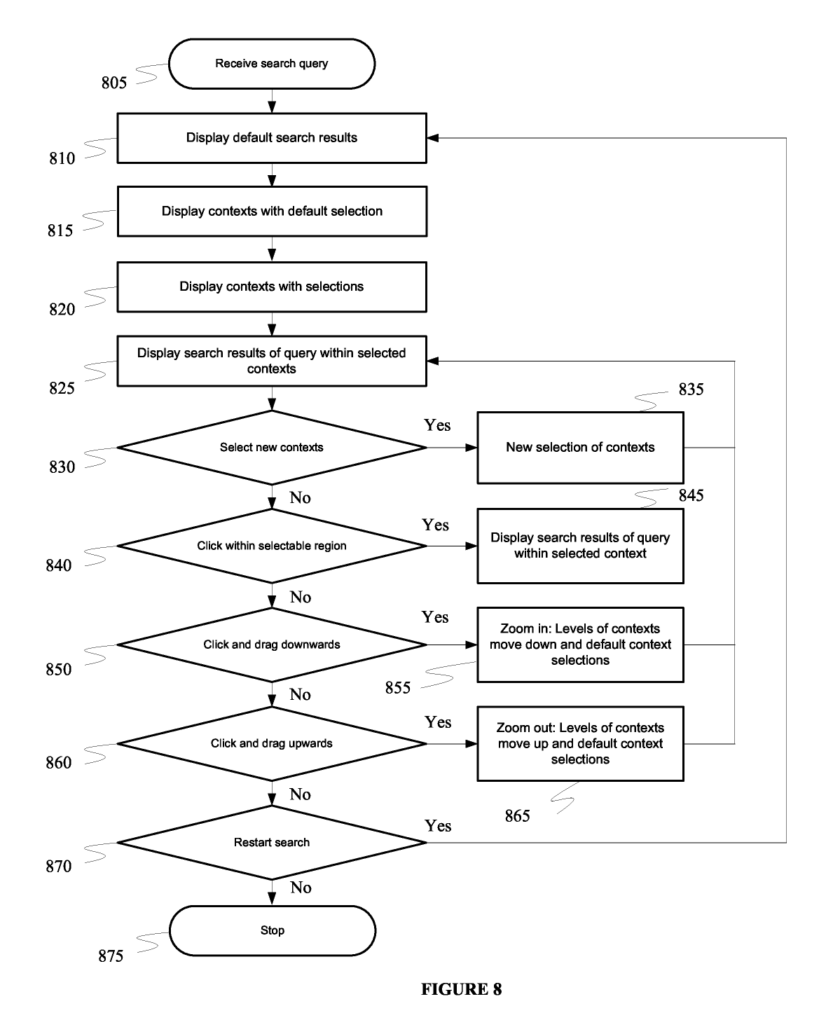

FIG. 8 illustrates an example method 800 for searching a query within selectable contexts. At step 805, the method receives a search query from a user. The query is generally in a natural language form. The query is indicated as an input query. The input query is provided to a search engine for processing. At step 810, the method displays default search results. The results are from any of the search engine available at the internet. At step 815 the method displays a set of contexts on a selectable list with a default selection of a subset of the contexts. The default selection of the subset of contexts is taken from the history of searches by the search engine.

At step 820, the method displays a selectable region (preferably in a circular region) that represents the selected contexts and their combination. The pointer of the cursor remains at a default location within the region. It may be at the centre of the circle if the selectable region is a circular graph. At step 825, the method displays the search results of the query within the selected contexts.

At step 830, the method allows the user to select a set of contexts different from the default selections. If the user selects a new set of contexts from the selectable list, the selectable region (graphical region or graph window) appears to represent the newly selected contexts and their combinations. The pointer remains at the default child location with the circular region. At step 835, the method displays the search results within the selected contexts on the screen. After the selection of contexts in the selectable list by the user, the method goes back to step 825 for displaying the search results of query within selected contexts on the screen.

At step 840, user clicks the pointer away from the default location within the selectable region. The method displays a new list of search results, relevant to the combination of topics representing the location of the pointer, on the screen (at step 845).

At step 850, user clicks and drags downwards at any point within the selectable region. At step 855, the method displays a new set of selectable child contexts (zooming in) on the selectable list with a default selection of contexts. The selectable region appears to represent the selected contexts and their combinations. The pointer comes to the default location and method displays a list of search results, relevant to the selected contexts. The distance dragged is proportional to the number of levels zoomed in.

At step 860, user clicks and drags upwards at any point within the selectable region. At step 865, the method displays a new set of selectable parent contexts (zooming out) appears on the selectable list with a default subset of contexts already selected. The selectable region appears that represents the selected contexts and their combination. The pointer remains at the default location and method displays a list of search results, relevant to the selected contexts. The distance dragged up is proportional to the number of levels zoomed out.

At step 870, the method ask for restarting the search, if yes then method go back to step 805, else the method moves to step 875 and stop the search.

Although the flowchart 800 includes steps 805-875 that are arranged serially in the exemplary embodiments, other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

The steps followed in a keyword search are explained below.
1. Action: User makes an arbitrary keyword search.
   a. A set of parent contexts appears on a selectable list with a default selection of a subset of parent contexts.
      i. The default level of the context can be configured initially
      ii. Default selection can be based on a criteria of relevance
      iii. Relevance can be based on historical selection of the contexts
   b. A selectable region (such as a circular region) appears that represents the selected parent contexts and their combinations. The pointer remains at a default location within the region. It could be the center of the circle if the selectable region is a circular one.
   c. List of default search results appears on a screen.
2. Action: User selects a set of parent contexts different from the default selections.
   a. The selectable region appears to represent the newly selected parent contexts and their combinations. The pointer remains at the default child location within the region
   b. List of search results, relevant to the newly selected contexts, appears on the screen
3. Action: User clicks the pointer away from the default location within the selectable region.
   a. A new list of search results, relevant to the combination of contexts representing the location of the pointer, appears on the screen.
3. Action: User clicks and drags downwards at any point within the selectable region.
   a. A new set of selectable child contexts (narrower context) appears on the selectable list with a default subset of contexts already selected.
   b. The selectable region appears to represent the selected contexts and their combinations. The pointer remains at the default location.
   c. List of search results, relevant to the selected contexts, appears
   d. The distance dragged is proportional to the number of levels of narrowing down.
5. Action: User clicks and drags upwards at any point within the selectable region.
   a. A new set of selectable parent contexts (broader context) appears on the selectable list with a default subset of parent contexts already selected.
   b. The selectable region appears that represents the selected contexts and their combinations. The pointer remains at the default location.
   c. List of search results, relevant to the combination of contexts, appears
   d. The distance dragged is proportional to the number of levels of broadening up.

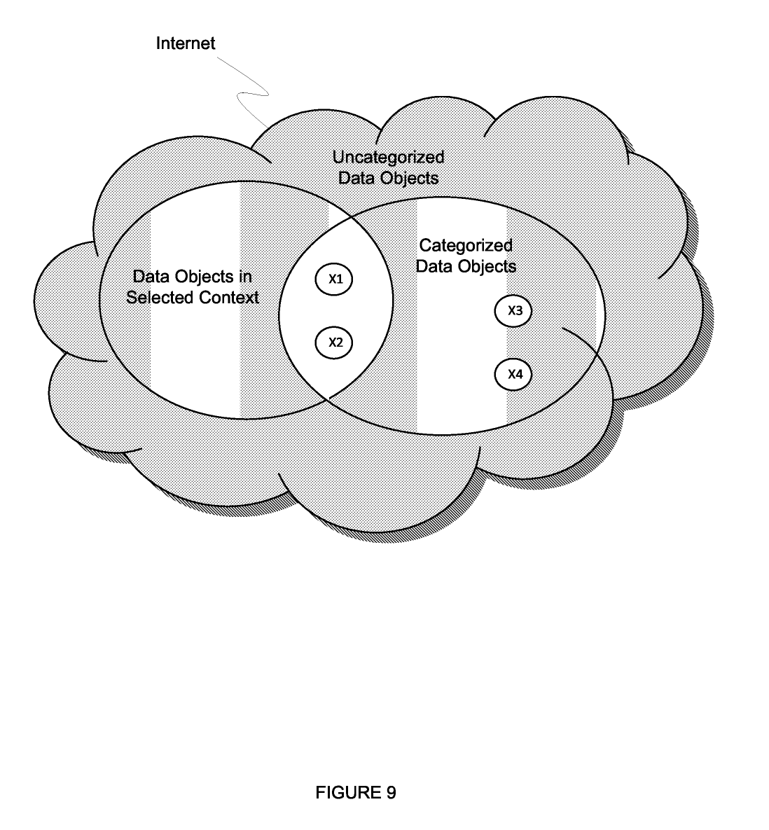

FIG. 9 shows sets of categorized data objects, uncategorized data objects, and data objects belonging to the selected context. The data objects available in the internet can be divided into multiple groups as illustrated in FIG. 9. The set of data objects belonging to a selected context could overlap with sets of categorized data objects and uncategorized data objects. The categories that belong to the overlapped region (e.g., X1 and X2) should be given higher priority in the search domain to increase the number of relevant search results and the categories that do not belong to the selected context (e.g., X3 and X4) should be removed from the search domain to reduce the number of irrelevant search results.

The present invention may be implemented with a variety of combination of hardware and software. If implemented as a computer-implemented apparatus, the present invention is implemented using means for performing all of the steps and functions described above.

The present invention can be included in an article of manufacture (e.g., one or more computer program products) having, for instance, computer usable media. The media has embodied therein, for instance, computer readable program code means for providing and facilitating the mechanisms of the present invention. The article of manufacture can be included as part of a computer system or sold separately.

FIGS. 1-9 are merely representational and are not drawn to scale. Certain portions thereof may be exaggerated, while others may be minimized. FIGS. 1-9 illustrate various embodiments of the invention that can be understood and appropriately carried out by those of ordinary skill in the art.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the detailed description of embodiments of the invention, with each claim standing on its own as a separate embodiment.

It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively.

What is claimed is:

1. A method of providing assistance to the user for searching data objects within an application domain over an internet, the method comprising:
providing the user with a plurality of contexts relating to the application domain;
enabling navigation by the user among the plurality of contexts to select one or more contexts;
mapping the selected contexts onto a category representing the data objects; and
providing the search results relevant to the selected context or contexts.

2. The method of claim 1 wherein the step of mapping including identifying of category irrelevant to the selected contexts in order to reduce the number of irrelevant data objects from the search results.

3. The method of claim 1 wherein the step of mapping including identifying of category relevant to the selected contexts in order to increase the number of relevant data objects in the search results.

4. The method of claim 1 wherein the contexts are independent of user query and data objects, and wherein the contexts are arranged in multiple levels following a hierarchical taxonomical structure.

5. The method of claim 1 wherein the contexts are not classified out of data objects.

6. The method of claim 1 wherein the application domain includes field of education.

7. The method of claim 1 wherein the application domain includes at least one of agriculture and medical application.

8. A method of providing assistance to the user for searching data objects within an application domain over an internet, the method comprising:
providing a plurality of contexts relating to the application domain at a first level; and
providing a plurality of contexts relating to the application domain at a second level using a separate region, said region defining a boundary.

9. The method of claim 8 wherein the contexts are independent of user query and data objects, and wherein the contexts are arranged in multiple levels following a hierarchical taxonomical structure.

10. The method of claim 8 further including allowing the user to navigate and click at any location within the region to retrieve the context corresponding to the clicked location, wherein the degree of relevance of the selected context varies in proportion to the average distance of the clicked location from the boundary location representing the context.

11. The method of claim 10 further including allowing the user to shift to a desired hierarchy level of the context by clicking and dragging the cursor within the region.

12. The method of claim 8 wherein the application domain includes field of education.

13. The method of claim 8 wherein the application domain includes at least one of agriculture and medical application.

14. A system of providing assistance to the user for searching data objects within an application domain over an internet, the system comprising:
a server having a module for providing a plurality of contexts relating to the application domain wherein the contexts are arranged in multiple levels following a hierarchical taxonomical structure.

15. A computer readable medium for storing computer implementable instructions, said instructions for causing a compliance mechanism to perform a method of providing assistance to the user for searching data objects within an application domain over an internet, the method comprising:
providing the user with a plurality of contexts relating to the application domain;
enabling navigation by the user among the plurality of contexts to select one or more contexts;
mapping the selected contexts onto a category representing the data objects; and
providing the search results relevant to the selected context or contexts.

16. The method of claim 15 wherein the step of mapping further including the identification of categories irrelevant to the selected contexts in order to reduce the number of irrelevant data objects from the search results.

17. The method of claim 15 wherein the step of mapping further including the identification of categories relevant to the selected contexts in order to increase the number of relevant data objects in the search results.

18. The medium of claim 15 wherein the contexts are independent of user query and data objects, and wherein the contexts are arranged in multiple levels following a hierarchical taxonomical structure.

19. The medium of claim 15 wherein the contexts are not classified out of data objects.

20. The medium of claim 15 wherein the application domain includes field of education.

21. The medium of claim 15 wherein the application domain includes at least one of agriculture and medical application.

22. A computer readable medium for storing computer implementable instructions, said instructions for causing a compliance mechanism to perform a method of providing assistance to the user for searching data objects within an application domain over an internet, the method comprising:
providing a plurality of contexts relating to the application domain at a first level; and
providing a plurality of contexts relating to the application domain at a second level using a separate region, said region defining a boundary.

23. The medium of claim 22 wherein the contexts are independent of user query and data objects, and wherein the contexts are arranged in multiple levels following a hierarchical taxonomical structure.

24. The medium of claim 22 further including allowing the user to navigate and click at any location within the region to retrieve the context corresponding to the clicked location, wherein the degree of relevance of the selected context varies in proportion to the average distance of the clicked location from the boundary location representing the context.

25. The medium of claim 22 further including allowing the user to shift to a desired hierarchy level of the context by clicking and dragging the cursor within the region.

26. The medium of claim 22 wherein the application domain includes field of education.

27. The medium of claim 22 wherein the application domain includes at least one of agriculture and medical application.
